(19) United States
(12) Patent Application Publication
(10) Pub. No.: US 2016/0134960 A1
(43) Pub. Date: May 12, 2016

(54) RECHARGEABLE HEARING DEVICE, A BATTERY CHARGER FOR CHARGING SUCH A HEARING DEVICE AND A METHOD OF CHARGING SUCH A HEARING DEVICE

(71) Applicant: SONOVA AG, Stäfa (CH)

(72) Inventors: Leo DEN HARTOG, Zurich (CH); Christian FREI, Stafa (CH)

(21) Appl. No.: 14/896,693

(22) PCT Filed: Jun. 13, 2013
(86) PCT No.: PCT/EP2013/062283

§ 371 Date: Dec. 8, 2015

(51) Int. Cl. H04R 1/10; H04R 25/00

(52) U.S. Cl. CPC H04R 1/1025; H04R 25/305; H04R 2225/31

(57) ABSTRACT

A hearing device powered by a rechargeable battery. The hearing device includes an input converter, a signal processing unit, an output converter, a rechargeable battery for supplying power, at least one charging contact located at an outer surface of the hearing device for feeding electrical energy into the battery, and a magnetically activated switch interconnected in between the charging contact and the battery. A battery charger is used for charging such a hearing device as well as a method of charging such a hearing device.

### TECHNICAL FIELD

The present invention relates to a hearing device powered by a rechargeable battery. The present invention further pertains to a battery charger for charging such a hearing device as well as to a method of charging such a hearing device.

### BACKGROUND OF THE INVENTION

Many portable electronic devices are powered by rechargeable batteries. There is also the need for recharging solutions in the field of miniature hearing devices. However, recharging solutions known from portable electronic devices such as mobile phones, PDAs, multimedia players, cameras or tablet computers are often not suitable for miniature hearing devices, where space is very limited, health safety is a prime concern, and usage at the human body gives rise to special challenges.

Miniature hearing devices are typically adapted to be worn at an ear or at least partially within an ear canal of a user in the form of behind-the-ear (BTE), in-the-ear (ITE) and completely-in-canal (CIC) hearing devices. Such hearing devices include ear phones, communication devices, hearing aids (also referred to as hearing prostheses or hearing instruments) for hard of hearing people or hearing enhancement devices for augmenting the hearing capability of normal hearing persons, as well as active hearing protection devices designed to prevent noise-induced hearing loss or other damage to the hearing like tinnitus. Due to the small size of such hearing devices the batteries employed therein are tiny and therefore often difficult to handle, e.g. when replacing a depleted battery with a new one, especially for elderly users with reduced dexterity. Hence, the use of rechargeable batteries which do not need to be removed from a hearing device for recharging represent a considerable improvement for such users. Furthermore, such hearing devices are typically utilised for prolonged periods of time, e.g. during most of the day on a daily basis, so the batteries need to be replaced very often, for instance every few days. This puts a substantial financial burden on the users of such hearing devices due to the considerable cost of the batteries required for operating them. Therefore, the use of rechargeable batteries substantially reduces the operating costs of such hearing devices.

In particular hearing devices to be worn at least partially within an ear canal profit from using a built-in rechargeable battery instead of a traditional single-use, disposable zinc air battery, because this relieves the user from having to perform the tedious task of replacing the very small, e.g. size 10A, battery when it is empty. Rechargeable batteries are especially beneficial for hearing devices intended to be worn deeply within the ear canal, e.g. within the bony portion. U.S. Pat. No. 6,205,227 B1 relates to a peritympanic hearing instrument, WO 00/32009 A2 relates to a semi-permanent canal hearing device, and WO 00/76271 A1 relates to an extended wear canal hearing device. Such deep-fitted hearing devices are typically worn constantly over a prolonged period of time, e.g. many days up to weeks, without being removed since their insertion and extraction is a tricky and quite awkward procedure sometimes requiring the help of a specialist. Consequently, the battery needs to be sealed into the hearing device in order to prevent sweat from disrupting battery operation. Hence, replacement of the battery is not possible and so it has to be rechargeable. Since the battery is built into the hearing device there is no need for a battery door to remove the battery, which helps to minimise the size of the hearing device. Due to the significant cost of a single-use battery the minimal capacity has to be larger and therefore the size of the battery has to be bigger for single-use batteries than for rechargeable batteries. The smaller dimensions of rechargeable batteries thus allows a further miniaturisation of a hearing device employing a rechargeable battery.

For recharging the battery the hearing device is typically linked to a battery charger via electrical contacts provided at the housing of the hearing device. US 2008/0118093 A1 describes a contact element that is resiliently mounted at a hearing device and can be pressed onto a charging contact of an external charging device during charging under application of a positive force. The contact element is located in a first position during normal operation of the hearing device and is moved into a second position for charging. A magnetic element in the charging device can be used to hold the hearing device in order to press the contact element of the hearing device against the charging contact of the charging device. Alternatively, the charging device exhibits a receptacle adapted to the shape of the hearing device, and the contact element of the hearing device is pressed against the charging contact of the charging device when the hearing device is clamped into the receptacle by means of a clamp.

Employing charging contacts which are located at an exterior surface of a hearing device can give rise to a number of problems. Humidity between contacts can lead to leakage currents which discharge the battery. Furthermore, when certain material or liquid like for instance sweat comes into contact with the charging contacts corrosion and oxidation will occur, especially if the contacts are energised. Leakage currents conducted by the skin between charging contacts for a prolonged period of time may lead to skin irritations of the hearing device user due to galvanic effects. It is therefore desirable to avoid contact of the charging contacts with humidity and the skin. This can for instance be achieved by sealing the contacts or removing them from the exterior surface, whilst the battery is not being charged. In US 2008/0118093 A1for example a hearing device is proposed featuring a contact element that can be moved from an exposed position for charging to a concealed position when not in use.

Leakage currents can be avoided by ensuring that the charging contacts are not energised, i.e. at a zero potential, after charging has been completed. This is for instance the case with the rechargeable hearing device disclosed in US 2009/0034749 A1, which features a charging contact that is accessible from the outside and movable relative to the battery. The charging contact can be electrically conductively connected to the battery in a first position and not conductively connected thereto in a second position. Herewith, charging the battery of the hearing device using a direct conductive contact is possible, whilst zero potential of the charging contacts is ensured during normal operation of the hearing device.

However, the mechanical solutions as employed in the stated prior art hearing devices for disconnecting the charging contacts from the battery or for retracting the charging contacts into a concealed position when not in use, have a number of drawbacks such as consuming considerable space in a hearing device, high manufacturing complexity and cost, as well as long-term reliability issues.

### SUMMARY OF THE INVENTION

It is therefore an object of the present invention to provide an improved rechargeable hearing device with external charging contacts which overcomes the above stated drawbacks of the prior art solutions. This object is reached by the hearing device according to claim 1.

It is a further object to provide a battery charging device suitable for charging the improved rechargeable hearing device. Such a battery charger is specified in claim 9.

Moreover, it is another object to provide a method of charging the improved rechargeable hearing device. Such a charging method is proposed in claim 13.

Specific embodiments of the present invention are given in the dependent claims.

The present invention is first directed to a hearing device, comprising:
an input converter for receiving an input signal;
a signal processing unit for processing the input signal and for providing a processed signal;
an output converter for outputting the processed signal;
a rechargeable battery for supplying power to the input converter, the signal processing unit, and the output converter;
at least one charging contact located at an outer surface of the hearing device for feeding electrical energy into the battery, and

further comprising a magnetically activated switching means interconnected in between the at least one charging contact and the battery.

In an embodiment of the hearing device the switching means is adapted to connect the at least one charging contact with the battery when sensing a magnetic field with a field-strength above a first threshold, and in particular to disconnect the at least one charging contact from the rechargeable battery when no magnetic field is sensed.

In a further embodiment of the hearing device the switching means is adapted to disconnect the at least one charging contact from the battery when the sensed magnetic field has a field-strength below a second threshold, wherein the first threshold is greater than the second threshold, in particular the first threshold is 5% greater than the second threshold, more particularly the first threshold is 10% greater than the second threshold. The hysteresis in respect of connecting and disconnecting leads to a more stable charging process of the hearing device. It prevents oscillation as well as unwanted behaviour in the presence of electromagnetic disturbances.

In a further embodiment of the hearing device the switching means comprises a magnetoresistive sensor for sensing a magnetic field.

In a further embodiment of the hearing device the sensor makes use of the giant magnetoresistive (GMR) effect or the tunnel magnetoresistive effect (TMR) for sensing the magnetic field.

In a further embodiment of the hearing device the switching means is a GMR or TMR switch, viz. a device comprising a GMR or TMR sensor and at least one (preferably solid-state) switch, the switching of which is triggered by an output signal of the GMR or TMR sensor.

While GMR and TMR based sensors are preferred, other sensors could also be used. However, these other sensors have some drawbacks. Sensors which make use of the anisotropic magnetoresistive (AMR) effect or the hall effect for sensing the magnetic field are large and power consuming. Reed switches require more space and suffer from mechanical wear and chatter.

In a further embodiment of the hearing device the signal processing unit and the switching means are both packaged in a hybrid circuit, i.e. a miniaturised electronic circuit assembly constructed of individual components bonded to a substrate or printed circuit board (PCB) such as a foldable flex-print, e.g. a multichip module (MCM).

In a further embodiment of the hearing device the first threshold is in the range from 10 to 30 Oersted. The first threshold is matched to the (electro-)magnet employed in the charger so as to achieve a reliable switching function.

The present invention is further directed to a battery charger for charging a hearing device having at least one charging contact located at an outer surface of the hearing device for feeding electrical energy into a rechargeable battery and a magnetically activated switching means interconnected in between the at least one charging contact and the battery, the charger comprising:
a controllable current source;
a connector adapted to connect the current source with the at least one charging contact;
a control unit adapted to control a level of a charging current and/or of a charging voltage provided by the current source, and

further comprising a magnetic means for providing a magnetic field adapted to activate the magnetically activated switching means, in particular when the connector is connected with the at least one charging contact.

In an embodiment of the charger the magnetic means is a permanent magnet or an electromagnet.

In a further embodiment of the charger the magnetic field generated by the electromagnet is controllable by the control unit.

In a further embodiment of the charger the control unit is adapted to prevent the magnetic means from providing a magnetic field when charging of the battery is completed.

Moreover, the present invention is additionally directed to a method of charging a hearing device having at least one charging contact located at an outer surface of the hearing device for feeding electrical energy into a rechargeable battery and a magnetically activated switching means interconnected in between the at least one charging contact and the battery, the method comprising the steps of:
connecting a current source to the at least one charging contact;
applying an external magnetic field adapted to trigger the magnetically activated switching means so that the at least one charging contact is connected with the battery;
providing a charging current and/or a charging voltage from the current source to the battery;
removing or reducing the external magnetic field to trigger the magnetically activated switching means so that the at least one charging contact is disconnected from the battery.

In an embodiment of the method the external magnetic field is generated by an electromagnet.

In a further embodiment of the method the electromagnet is controlled by a charging control unit, which further controls a level of the charging current and/or of the charging voltage provided by the current source to the battery.

In a further embodiment of the method the magnetically activated switching means is adapted to detect a predetermined temporal pattern (i.e. a specific trace over time) of the magnetic field-strength and thereupon trigger connecting the at least one charging contact with the battery. Correspondingly, the electromagnet is controlled by the charging control unit to generate a magnetic field with the predetermined temporal pattern (i.e. the specific trace over time) of the magnetic field-strength. Such an embodiment is intended to operate in the presence of a concurrent magnetic field for instance generated by the miniature loudspeaker of the hearing device itself or originating from an inductive transmission generated by an external inductive loop. Such a scheme is also suitable when a permanent magnet is employed, e.g. for generating a holding force to connect the hearing device with a charger, or more specifically to press the contact element of the hearing device against the charging contact of the charging device such as proposed in US 2008/0118093 A1.

It is pointed out that combinations of the above-mentioned embodiments can yield even further, more specific embodiments according to the present invention.

### BRIEF DESCRIPTION OF THE DRAWINGS

The present invention is further explained below by means of non-limiting specific embodiments and with reference to the accompanying drawings, which show:

FIG. 1 a) a block diagram of an exemplary embodiment of a rechargeable hearing device according to the present invention illustrating the case where no magnetic field is present and the charging contacts are disconnected from the battery;

b) a block diagram of an exemplary embodiment of a rechargeable hearing device according to the present invention illustrating the case where a magnetic field is present and the charging contacts are connected with the battery; and

FIG. 2 a block diagram of exemplary embodiments of a battery charger and of a rechargeable hearing device according to the present invention illustrating the case where a magnetic field is present and the charging contacts are connected with the battery, i.e. where the battery charger is charging the battery of the hearing device.

In the figures, like reference signs refer to like parts.

### DETAILED DESCRIPTION OF THE INVENTION

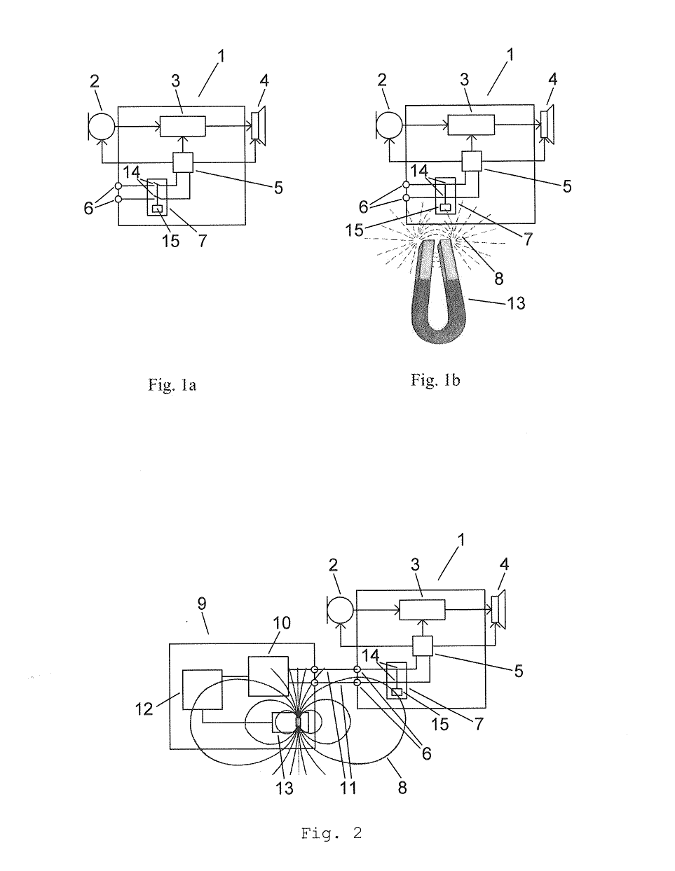

FIG. 1a) depicts a block diagram of an exemplary embodiment of a rechargeable hearing device 1 according to the present invention. The hearing device 1 comprises an input converter 2 for receiving an input signal, a signal processing unit 3 for processing the input signal and for providing a processed signal, and an output converter 4 for outputting the processed signal. The input converter 2 can for instance be a microphone (i.e. an acoustical/mechanical-to-electrical transducer) for picking up sound from the surroundings, or a signal reception unit, such as a T-coil (i.e. an inductive signal reception unit) or a more general wireless receiver (e.g. an FM or Bluetooth receiver) for receiving sound representing signals transmitted from a remote location. The received audio signal is then processed by the signal processing unit 3, e.g. to apply an amplification, and subsequently output by the output converter 4, which can be any form of electrical-to-mechanical transducer, e.g. a miniature loudspeaker, a DACS device for the direct acoustical stimulation of the middle ear or a cochlear implant. A rechargeable battery 5 is provided within the hearing device 1 to power all the electrical components. In order to allow charging of the battery 5 the hearing device 1 features at its outer surface two electrical charging contacts 6, for instance at a faceplate of the hearing device 1. Furthermore, a magnetically activated switching means 7 is interconnected in between the charging contacts 6 and the battery 5. This makes it possible to disconnect the two charging contacts 6 from the battery 5 when the battery 5 is not being charged. The two switches 14 within the switching means 7 are switched under the control of the magnetoresistive sensor 15. The sensor 15 is capable of detecting the presence of a magnetic field 8. When the field-strength of the magnetic field 8 detected by the sensor 15 is above a certain “connect” threshold the switches 14 are controlled to close and connect the battery 5 with the charging contacts 6, as in the case illustrated in FIG. 1b). As soon as the field-strength of the magnetic field 8 detected by the sensor 15 falls below as certain “disconnect” threshold the switches 14 are controlled to open and disconnect the battery 5 from the charging contacts 6, as in the case illustrated in FIG. 1a). In this way it can be ensured that the two charging contacts 6 are not energised when the hearing device 1 is being used in normal operation. Hence, no leakage current flows through the two charging contacts 6 and unnecessary draining of the battery 6 is avoided. The two switching thresholds are for instance chosen at different levels, e.g. the “connect” threshold is set to be higher than the “disconnect” threshold, so that a switching hysteresis is achieved in order to avoid back and forth flipping of the switches 14 when the field-strength is at a level close to the switching thresholds. The sensor 15 is adapted to detect magnetic field-strengths in the range from 10 to 30 Oersted (1 Oe=1 Gauss in air).

Basically, various magnetically activated switching means can be employed such as for instance a reed switch, a magnetic switch based on the Hall effect, or switches based on magnetoresistive sensors, e.g. which make use of the anisotropic magnetoresistive (AMR), the giant magnetoresistive (GMR) effect, the spin dependent tunnelling (SDT) effect or the tunnel magnetoresistive (TMR) effect. Of these different candidates, GMR and TMR switches are especially suitable for being utilised in hearing devices where small size, low power consumption and high reliability are major requirements, which are all very well met with the use of GMR and TMR switches. The larger size and low sensitivity make Hall effect based magnetic switches less appropriate, and the large size and high cost of AMR sensors make these less adequate for hearing device applications. A GMR or TMR switch 7 comprising a GMR or TMR sensor 15 (together with associated signal processing electronics) and solid state switches 14 represents a most suitable solution for controllably connecting the charging contacts 6 with the battery 5 in a small hearing device 5 to be worn at an ear or (partly) within an ear canal of a user. Due to its small size of approximately 1 mm² the GMR or TMR switch 7 can be packaged as part of a hybrid circuit together with the signal processing unit 3 and other miniature electronics components. The GMR or TMR switch 7 can also be arranged separately with a predefined orientation for instance directly at the charging contacts 6, and can for example be integrated into a faceplate of the hearing device 1.

FIG. 2 depicts a block diagram of an exemplary embodiment of a battery charger 9 according to the present invention. The battery charger 9 comprises a controllable current source 10, a connector adapted to connect the current source 10 with the charging contacts 6 located at the outer surface of the hearing device 1, a control unit 12 adapted to control the level of the charging current and/or of the charging voltage provided by the current source 10 to the rechargeable battery 5 of the hearing device 1.

Furthermore, the charger 9 comprises a magnetic means 13 such as a permanent magnet or more preferably an electromagnet for providing an external magnetic field 8 (from the charger 9 to the hearing device 1) adapted to activate the GMR or TMR switch 7 within the hearing device 1 so that the current source 10 is connected with the battery 5 for charging. The magnetic field 8 generated by the electromagnet 13 can be controlled by the control unit 12, such that it has the required field-strength necessary to trigger to switches 14 to connect and disconnect. When the control unit 12 initiates charging of the battery 5, a current is supplied to the electromagnet 13 such that the magnetic field 8 generated at the location of the GMR or TMR sensor 15 is above a specified “connect” threshold. The switches 14 are therefore closed and the charging contacts 6 and hence the current source 10 is connected with the battery 5. Once charging of the battery 5 is completed, the current applied to the electromagnet 13 is discontinued by the control unit 12. When the field-strength of the magnetic field 8 at the location of the GMR or TMR sensor 15 falls below a specified “disconnect” threshold the switches 14 are opened again, and the charging contacts 6 are disconnected from the battery 5.

The proposed hearing device 1 with a GMR or TMR switch 7 for disconnecting of the charging contacts 6 from the battery 5 provides a number of advantages over presently known approaches such as for instance the one described in US 2009/0034749 A1. Problems associated with wearing out of the charging contacts 6 if they are used as part of a mechanical switching solution are avoided. Furthermore, since solid state switches are employed the problems encountered with mechanical switches such as e.g. sealing against humidity, the associated oxidation as well as mechanical stress are also avoided. Thus, a high reliably is achieved over the entire lifetime of the hearing device without compromising its size even in the case of a very small CIC hearing device such as is required for deep fittings within the inner, bony portion of the ear canal. With the hearing device according to the present invention, no leakage current will occur, because the charging contacts can be disconnected from the battery. Consequently, it is not necessary to specifically avoid contact of the charging contacts with the skin, e.g. by sealing them off or retracting them when not being used, in order to prevent skin irritations or possible other harm caused by leakage currents being conducted by the skin.

What is claimed is:

1. A hearing device (1), comprising:
an input converter (2) for receiving an input signal;
a signal processing unit (3) for processing the input signal and for providing a processed signal;
an output converter (4) for outputting the processed signal;
a rechargeable battery (5) for supplying power to the input converter (2), the signal processing unit (3), and the output converter (4);
at least one charging contact (6) located at an outer surface of the hearing device (1) for feeding electrical energy into the battery (5),
characterised in further comprising a magnetically activated switching means (7) interconnected in between the at least one charging contact (6) and the battery (5).

2. The hearing device (1) of claim 1, characterised in that the switching means (7) is adapted to connect the at least one charging contact (6) with the battery (5) when sensing a magnetic field (8) with a field-strength above a first threshold, and in particular to disconnect the at least one charging contact (6) from the battery (5) when no magnetic field (8) is sensed.

3. The hearing device (1) of claim 2, characterised in that the switching means (7) is adapted to disconnect the at least one charging contact (6) from the battery (5) when the sensed magnetic field (8) has a field-strength below a second threshold, wherein the first threshold is greater than the second threshold, in particular the first threshold is 5% greater than the second threshold, more particularly the first threshold is 10% greater than the second threshold.

4. The hearing device (1) of claim 1, characterised in that the switching means (7) comprises a magnetoresistive sensor (15) for sensing a magnetic field (8).

5. The hearing device (1) of claim 4, characterised in that the sensor (15) makes use of the giant magnetoresistive effect or the tunnel magnetoresistive effect for sensing the magnetic field (8).

6. The hearing device (1) of claim 1, characterised in that the switching means (7) is a GMR or TMR switch (7).

7. The hearing device (1) of claim 1, characterised in that the signal processing unit (3) and the switching means (7) are both packaged in a hybrid circuit.

8. The hearing device (1) of claim 2, characterised in that the first threshold is in the range from 10 to 30 Oersted.

9. A battery charger (9) for charging a hearing device (1) having at least one charging contact (6) located at an outer surface of the hearing device (1) for feeding electrical energy into a rechargeable battery (5) and a magnetically activated switching means (7) interconnected in between the at least one charging contact (6) and the battery (5), the charger (9) comprising:
a controllable current source (10);
a connector (11) for connecting the current source (10) with the at least one charging contact (6);
a control unit (12) for controlling a level of a charging current and/or of a charging voltage provided by the current source (10),
characterised in further comprising a magnetic means (13) for providing a magnetic field (8) adapted to activate the magnetically activated switching means (7), in particular when the connector (11) is connected with the at least one charging contact (6).

10. The charger (9) of claim 9, characterised in that the magnetic means (13) is a permanent magnet or an electromagnet (13).

11. The charger (9) of claim 10, characterised in that the magnetic field (8) generated by the electromagnet (13) is controllable by the control unit (12).

12. The charger (9) of claim 9, characterised in that the control unit (12) is adapted to prevent the magnetic means (13) from providing a magnetic field (8) when charging of the battery (5) is completed.

13. A method of charging a hearing device (1) having at least one charging contact (6) located at an outer surface of the hearing device (1) for feeding electrical energy into a rechargeable battery (5) and a magnetically activated switching means (7) interconnected in between the at least one charging contact (6) and the battery (5), the method comprising the steps of:
connecting a current source (10) to the at least one charging contact (6);
applying an external magnetic field (8) adapted to trigger the magnetically activated switching means (7) so that the at least one charging contact (6) is connected with the battery (5);
providing a charging current and/or a charging voltage from the current source (10) to the battery (5);
removing or reducing the external magnetic field (8) to trigger the magnetically activated switching means (7) so that the at least one charging contact (6) is disconnected from the battery (5).

14. The method of claim 13, characterised in that the external magnetic field (8) is generated by an electromagnet (13).

15. The method of claim 14, characterised in that the electromagnet (13) is controlled by a charging control unit (12), which further controls a level of the charging current and/or of the charging voltage provided by the current source (10) to the battery (5).
